(19) United States
(12) Patent Application Publication
(10) Pub. No.: US 2020/0014069 A1
(43) Pub. Date: Jan. 9, 2020

(54) SECONDARY BATTERY WITH IMPROVED HIGH-TEMPERATURE AND LOW-TEMPERATURE PROPERTIES

(71) Applicant: SK INNOVATION CO., LTD., Seoul (KR)

(72) Inventor: Jae-Yun MIN, Daejeon (KR)

(21) Appl. No.: 16/576,292

(22) Filed: Sep. 19, 2019

Related U.S. Application Data
(63) Continuation of application No. 14/747,755, filed on Jun. 23, 2015.

(30) Foreign Application Priority Data
Jun. 26, 2014 (KR) 10-2014-0078985

(51) Int. Cl. H01M 10/0569; H01M 4/62; H01M 10/0525

(52) U.S. Cl. CPC H01M 10/0569; H01M 4/622; H01M 2004/028; H01M 10/0525; H01M 2300/0034; H01M 4/625

(57) ABSTRACT

A secondary battery includes: a cathode; an anode; and an electrolyte, wherein the cathode includes a cathode current collector; a carbon layer including a binder, and carbon; and an active material layer, and the electrolyte includes lithium hexafluorophosphate (LiPF₆) and lithium bis(fluorosulfonyl)imide (LiFSI). The secondary battery according to the present invention may have improved high-temperature and low-temperature properties, and may inhibit corrosion of a cathode to have increased life.

### CROSS REFERENCE TO RELATED APPLICATION

This application is a continuation of U.S. patent application Ser. No. 14/747,755 filed on Jun. 23, 2015, which claims benefits of priority of Korean Patent Application No. 10-2014-0078985 filed on Jun. 26, 2014. The disclosure of each of the foregoing application is incorporated herein by reference in its entirety.

### TECHNICAL FIELD

The present invention relates to a secondary battery with improved high-temperature and low-temperature properties.

### BACKGROUND ART

A secondary battery is capable of being charged and discharged, and is used for a digital camera, an electric automobile, and a hybrid vehicle, a cell phone, and the like. The secondary battery includes a nickel-cadmium battery, a nickel-metal hydride battery, a nickel-hydrogen battery, a lithium secondary battery, and the like. Among them, the lithium secondary battery is widely used due to high operating voltage and excellent energy density per unit weight as compared to other secondary batteries such as the nickel-cadmium battery, the nickel-metal hybrid battery, and the like (Korean Patent Laid-Open Publication No. 2013-0097914).

Meanwhile, lithium hexafluorophosphate (LiPF₆) is a salt which is commonly used for an electrolyte of a secondary battery, but mobility of lithium ions is deteriorated at a low-temperature, and metal elution ions in a cathode active material due to hydrogen fluoride (HF) generation are accelerated at a high-temperature to cause capacity deterioration. In addition, when LiPF₆ has an excessively high content, swelling of the secondary battery (cell) is caused. Accordingly, as a result of a research into a secondary battery with both of improved high-temperature and low-temperature properties, the present inventors confirmed that at the time of using an electrolyte including lithium hexafluorophosphate (LiPF₆) and lithium bis(fluorosulfonyl)imide (LiFSI) at a specific ratio, and a cathode in which a cathode current collector is coated with a carbon layer, both of low-temperature and high-temperature properties of the secondary battery may be improved and life of the secondary battery may also be increased, and completed the present invention.

### DISCLOSURE

### Technical Problem

An aspect of the present invention is to provide a secondary battery with improved high-temperature and low-temperature properties.

### Technical Solution

In accordance with one aspect of the present invention, there is provided a secondary battery including: a cathode; an anode; and an electrolyte, wherein the cathode includes a cathode current collector; a carbon layer including a binder, and carbon; and an active material layer, and the electrolyte includes lithium hexafluorophosphate (LiPF₆) and lithium bis(fluorosulfonyl)imide (LiFSI).

### Advantageous Effects

The secondary battery according to the present invention may have improved high-temperature and low-temperature properties, and may inhibit corrosion of a cathode to have increased life.

### BEST MODE

The present invention is directed to providing a secondary battery including:

a cathode; an anode; and an electrolyte,

wherein the cathode includes a cathode current collector; a carbon layer including a binder, and carbon; and an active material layer, and

the electrolyte includes lithium hexafluorophosphate (LiPF₆) and lithium bis(fluorosulfonyl)imide (LiFSI).

Hereinafter, the present invention will be described in detail.

Cathode

The cathode of the present invention includes a laminate in which a cathode current collector, a carbon layer, and an active material layer are sequentially stacked.

Cathode Current Collector

The cathode current collector of the present invention is not specifically limited as long as it is a cathode current collector which is generally used for the secondary battery. For example, an aluminum foil is capable of being used as the cathode current collector of the present invention, but the present invention is not limited thereto.

Carbon Layer

The carbon layer of the present invention coats the cathode current collector, and prevents direct contact between the active material layer and the cathode current collector. When the carbon layer of the present invention does not exist, the cathode current collector is corroded by LiFSI salt in the electrolyte.

The carbon layer includes a binder and carbon.

The binder is preferably an N-methyl-2-pyrrolidone (NMP) insoluble binder. For example, examples of the binder of the carbon layer of the present invention include a polyacrylate-based binder, an alginate-based binder, polyvinyl alcohol or a styrene butadiene rubber (SBR)/carboxymethyl cellulose (CMC) binder, and the like, preferably, poly(acrylic acid) (PAA), poly(methyl methacrylate) (PMMA), polyvinyl alcohol (PVA), alginate, styrene butadiene rubber (SBR), carboxymethyl cellulose (CMC), and the like. When an N-methyl-2-pyrrolidone (NMP) soluble binder, for example, polyvinylidene fluoride (PVDF), or the like, is used as the binder, swelling of the carbon layer is caused due to NMP which is a solvent used at the time of coating a cathode active material layer, such that the cathode may be corroded. Therefore, it is preferred that the NMP soluble binder such as PVDF is not used in the carbon layer in the present invention.

The carbon is not specifically limited, but for example, the carbon may be selected from the group consisting of graphite, carbon black, acetylene black, carbon nanotube, graphene, Ketjen black and Denka black.

The carbon layer includes the carbon and the binder at a weight ratio of 1:0.2 to 1.2. When the binder has a weight ratio less than 0.2, coating of the carbon layer may not be sufficiently performed, and when the binder has a weight ratio more than 1.2, properties of the secondary battery are deteriorated due to strong resistance by the binder.

The carbon layer of the present invention may further include an appropriate conductive polymer, and the like, in addition to the binder and the carbon.

Active Material Layer

The cathode active material layer of the present invention includes N-methyl-2-pyrrolidone (NMP) as a solvent, and includes other active materials that are generally used in the cathode of the secondary battery, without limitation.

A binder used in the active material layer is not specifically limited. For example, the active material layer may be coated on the carbon layer by using PVDF, or the like, as the binder of the active material layer.

Electrolyte

The electrolyte of the present invention includes LiFSI and LiPF₆ at a weight ratio of 1:0.3 to 2.0. When a weight ratio of LiPF₆ is less than 0.3, or LiFSI is only used without using LiPF₆, a high-temperature property is deteriorated, and in particular, gas occurs in the secondary battery at a temperature of 70° C. or more to cause swelling, such that capacity retention ratio is decreased. Meanwhile, when the weight ratio of LiPF₆ is more than 2.0, or LiPF₆ is only used without using LiFSI, an effect of improving low-temperature output and high-temperature storage properties by LiFSI is not sufficient, such that mobility of lithium ions at a low-temperature is deteriorated, and LiPF₆ is easily degraded at a temperature of 50° C. to 60° C.

The electrolyte of the present invention may include solvents that are generally used for the electrolyte of the secondary battery such as ethylene carbonate, diethyl carbonate, dimethyl carbonate, and the like.

Secondary Battery

The present invention is directed to providing a secondary battery including: a cathode; an anode; and an electrolyte, wherein the cathode includes a cathode current collector; a carbon layer including a binder, and carbon; and an active material layer, and the electrolyte includes LiPF₆ and LiFSI.

The secondary battery according to the present invention has both of improved high-temperature and low-temperature properties. Here, the high-temperature indicates 65 to 75° C., preferably, 70° C., and the low-temperature indicates −30° C. In addition, the secondary battery according to the present invention prevents corrosion of the cathode by applying the carbon layer, to thereby have increased life. The reason is because the secondary battery according to the present invention includes LiFSI and LiPF₆ at a specific ratio to improve both of high-temperature and low-temperature properties, and corrosion of the cathode due to LiFSI is prevented by applying the carbon layer, and efficiency of the secondary battery is improved due to NMP of the cathode active material layer. Accordingly, the carbon layer of the secondary battery according to the present invention prevents swelling during the cycle of the secondary battery, and protects the cathode current collector.

Various advantages and features of the present invention and methods accomplishing thereof will become apparent with reference to Examples and Experimental Examples to be described in detail. However, the present invention is not limited to Examples and Experimental Examples disclosed herein but will be implemented in various forms. The present Examples and Experimental Examples are provided by way of example only so that a person of ordinary skilled in the art can fully understand the disclosures of the present invention and the scope of the present invention. Therefore, the present invention will be defined only by the scope of the appended claims.

### EXAMPLE 1

Manufacture of Cathode

An aluminum foil cathode current collector was prepared. Graphite powder and poly(acrylic acid) (PAA) were mixed at a weight ratio of 1:0.5 to prepare a slurry, and the slurry was applied and dried onto a cathode current collector, thereby manufacturing the cathode current collector coated with a carbon layer.

90% by weight of LiMn₂O₄ active material, 5% by weight of a graphite conductive material, 5% by weight of a polyvinylidene fluoride binder were mixed in an N-methyl pyrrolidone solvent to prepare a cathode active material slurry. The cathode active material slurry was applied and dried onto a current collector for a cathode to manufacture a cathode.

Electrolyte

A mixture obtained by mixing ethylene carbonate including LiPF₆ and LiFSI at 2 mol/L, diethyl carbonate, and dimethyl carbonate at a volume ratio of 2:1:2 was used as the electrolyte. Here, LiFSI and LiPF₆ were included at a weight ratio of 1:0.5.

Manufacture of Secondary Battery

An anode was prepared by using a silicon-graphite complex anode active material and a copper foil as an anode current collector. The cathode, the electrolyte, the anode, and a general separator were used to manufacture a secondary battery.

### EXAMPLE 2

A secondary battery was manufactured by the same method as Example 1 except for using LiFSI and LiPF₆ at a weight ratio of 1:1.2 in the electrolyte.

### EXAMPLE 3

A secondary battery was manufactured by the same method as Example 1 except for using PVA instead of using PAA, as the binder of the carbon layer.

### COMPARATIVE EXAMPLE 1

A secondary battery was manufactured by the same method as Example 1 except for using LiFSI only in the electrolyte, without using LiPF₆ (that is, ethylene carbonate including LiFSI at 2 mol/L was used).

### COMPARATIVE EXAMPLE 2

A secondary battery was manufactured by the same method as Example 1 except for using LiPF₆ only in the electrolyte, without using LiFSI (that is, ethylene carbonate including LiPF₆ at 2 mol/L was used).

### COMPARATIVE EXAMPLE 3

A secondary battery was manufactured by the same method as Example 1 except for using LiFSI and LiPF₆ at a weight ratio of 1:0.1 in the electrolyte.

### COMPARATIVE EXAMPLE 4

A secondary battery was manufactured by the same method as Example 1 except for using LiFSI and LiPF₆ at a weight ratio of 1:2.5 in the electrolyte.

### COMPARATIVE EXAMPLE 5

A secondary battery was manufactured by the same method as Example 1 except for using PVDF instead of using PAA, as the binder of the carbon layer.

### COMPARATIVE EXAMPLE 6

A secondary battery was manufactured by the same method as Example 1 except for directly applying a cathode active material slurry to the cathode current collector, and without using the carbon layer.

### EXPERIMENTAL EXAMPLE 1

Low-temperature output of each of the secondary batteries of Examples 1 to 3 and Comparative Examples 1 to 6 was evaluated. A specific evaluation method is as follows. Voltage (V1) was measured by lowering a temperature to be −30° C. in a state where SOC (state of charge) of each secondary battery was maintained at 30%, and maintaining the secondary battery for 4 hours. After the secondary battery was discharged at 30 A for 10 seconds, voltage (V2) was measured. Then, a straight line connecting two points of (Current, Voltage)=(0,V1) and (30,V2) was drawn, and a current (Imin) at the moment at which an extended line of the drawn straight line contacts 2.5V which is a lower limit voltage was read. Here, a low-temperature output was calculated by 2.5V×current (Imin).

As a result, the secondary batteries of Examples 1 to 3 exhibited good low-temperature output at a low-temperature such as −30° C., and the secondary batteries of Comparative Examples 1 and 3 also exhibited excellent low-temperature output. However, the secondary batteries of Comparative Examples 2 and 4 exhibited lowered conductivity of lithium ions at a low-temperature, and the cathode of the secondary battery of Comparative Example 6 was corroded (Table 1).

### EXPERIMENTAL EXAMPLE 2

High-temperature storage property of each of the secondary batteries of Examples 1 to 3 and Comparative Examples 1 to 6 was evaluated. A specific evaluation method is as follows. The batteries were charged with SOC of 95%, and left at 70° C. for 14 days. Then, capacity retention ratio of each secondary battery, and whether or not gas occurs in the batteries were confirmed (Table 1).

As a result, the secondary batteries of Examples 1 to 3 and Comparative Examples 4 and 5 exhibited good results even at a high-temperature of 70° C. However, it was confirmed that the electrolyte solvent and the LiPF₆ salt were degraded at a high-temperature in the secondary batteries of Comparative Example 1 and 3, and particularly, in Comparative Example 1, swelling occurred severely at a temperature of 70° C. or more. In addition, corrosion of the cathode in the secondary battery of Comparative Example 6 was confirmed (Table 1).

### EXPERIMENTAL EXAMPLE 3

After the secondary batteries of Examples 1 to 3 and Comparative Example 1 to 6 were continuously charged and discharged up to 200 cycles under 0.5 C charge and 1.0 C discharge conditions at room temperature (25° C.), capacity retention ratio after 200 cycles was evaluated. The capacity retention ratio was shown as a relative ratio of a capacity after 200 cycles to a capacity at the first cycle.

As a result, the secondary batteries of Examples 1 to 3 and Comparative Examples 1 and 4 exhibited good capacity retention ratio. However, it was confirmed that corrosion of the cathode occurred in the secondary batteries of Comparative Examples 5 and 6, and particularly, in Comparative Example 5, swelling of the carbon layer occurred (Table 1).

TABLE 1

| | | Capacity | Whether or | |
|---|---|---|---|---|
| | | Retention | not Swelling | |
| | | Ratio (%) | Occurs | |
| | Low- | during High- | during High- | |
| | Temperature | Temperature | Temperature | |
| | Output (W) | Storage at | Storage at | Cycle Life |
| | at −30° C. | 70° C. | 70° C. | (%) |
| Example 1 | 100 | 91 | No Occur | 95 |
| Example 2 | 93 | 87 | No Occur | 94 |
| Example 3 | 95 | 89 | No Occur | 94 |
| Comparative | 110 | 70 | Occur | 93 |
| Example 1 | | | Severely | |
| Comparative | 85 | 81 | No Occur | 93 |
| Example 2 | | | | |
| Comparative | 103 | 75 | Occur | 93 |
| Example 3 | | | Slightly | |
| Comparative | 87 | 84 | No Occur | 94 |
| Example 4 | | | | |
| Comparative | 101 | 87 | No Occur | 86 |
| Example 5 | | | | |
| Comparative | 88 | 79 | Occur | 89 |
| Example 6 | | | Slightly | |

1. A secondary battery comprising:
a cathode including a cathode collector, a carbon layer and an active material layer which are sequentially arranged;
an anode; and an electrolyte, wherein,
the carbon layer includes carbon and N-methyl-2-pyrrolidone (NMP) insoluble binder,
the active material layer includes an active material and N-methyl-2-pyrrolidone (NMP),
the electrolyte includes LiFSI and LiPF6 at a weight ratio of from 1:0.3 to 2.0.

2. The secondary battery of claim 1, wherein the carbon layer does not include an N-methyl-2-pyrrolidone (NMP) soluble binder.

3. The secondary battery of claim 1, wherein the carbon layer does not include the active material.

4. The secondary battery of claim 1, wherein the N-methyl-2-pyrrolidone (NMP) insoluble binder is a polyacrylate-based binder.

5. The secondary battery of claim 1, wherein the N-methyl-2-pyrrolidone (NMP) insoluble binder is polyvinyl alcohol.

6. The secondary battery of claim 1, wherein the N-methyl-2-pyrrolidone (NMP) insoluble binder is an alginate-based binder, or styrene butadiene rubber (SBR)/carboxymethyl cellulose (CMC).

7. The secondary battery of claim 1, wherein the carbon is selected from the group consisting of graphite, carbon black, carbon nanotube, grapheme and Ketjen black.

8. The secondary battery of claim 7, wherein the carbon black is Denka black.

9. The secondary battery of claim 1, wherein the carbon layer includes carbon and N-methyl-2-pyrrolidone (NMP) insoluble binder at a weight ratio of 1:0.2 to 1.2.

10. The secondary battery of claim 1, wherein the carbon layer prevents direct contact between the active material layer and the cathode current collector, thereby preventing corrosion of the cathode.

11. The secondary battery of claim 1, wherein swelling of the carbon layer is prevented when the secondary battery is left at 70° C. for 14 days.

12. The secondary battery of claim 1, wherein the electrolyte comprises ethylene carbonate, diethyl carbonate, and dimethyl carbonate.

13. The secondary battery of claim 13, wherein ethylene carbonate includes LiFSI and LiPF6.
